(19) United States
(12) Patent Application Publication
(10) Pub. No.: US 2008/0301142 A1
(43) Pub. Date: Dec. 4, 2008

(54) METHOD AND SYSTEM FOR ORGANIZING AND PRESENTING CONSTRUCTION KNOWLEDGE-SHARING TOOLS

(75) Inventor: Christian A. Marolf, Menlo Park, CA (US)

Correspondence Address: OSHA LIANG L.L.P., TWO HOUSTON CENTER, 909 FANNIN, SUITE 3500, HOUSTON, TX, 77010, US

(73) Assignee: IM-PROVE LLC, Menlo Park, CA (US)

(21) Appl. No.: 12/131,872

(22) Filed: Jun. 2, 2008

Related U.S. Application Data
(60) Provisional application No. 60/941,670, filed on Jun. 3, 2007.

(51) Int. Cl. G06F 17/30

(52) U.S. Cl. 707/9; 707/E17.007

(57) ABSTRACT

The invention is directed to a method and system for organizing a knowledge management platform to gather and share knowledge learned by construction project teams. The method involves authorizing access to the platform, wherein the platform comprises an integrated organizational scheme for organizing a project into one or more project elements, facilitating input of project data into the platform and storing project data based on the integrated organizational scheme, wherein project data comprises the knowledge learned by construction project teams, linking project data to one or more project elements in the integrated organizational scheme to obtain content, and presenting the content to user computers responsive to a request submitted to the platform. The integrated organizational scheme may include a top and a secondary level, wherein the top level includes a project management topic and a technical topic, and the secondary level includes a knowledge-sharing tool, content, and a topic-specific question.

### CROSS REFERENCE TO RELATED APPLICATION

This application claims priority under 35 U.S.C. §119 to U.S. Provisional Patent Application No. 60/941,670, filed on Jun. 3, 2007.

### BACKGROUND

Managing complex projects can be challenging, particularly in the construction industry. Part of the challenge is capturing best practices and lessons learned during projects, and making that information available company-wide for future projects. Currently, this exchange of information is made in the context of meetings and reduced to writing in the form of meeting minutes. The content and presentation formats of such minutes is generally neither standardized nor indexed to allow research of specific questions. In addition, meetings generally focus on deficiencies experienced in previous projects. Project teams, however, would also benefit from a prior team's systematic searches for a solution.

As a general rule, information databases are most useful when they make data entry and retrieval as intuitive as possible by organizing content into categories routinely used in a particular industry. In the area of project knowledge management, information is most useful when it is formatted as tools that teams can use to manage their projects. In areas where projects have defined phases, further tailoring of knowledge-sharing tools to correspond to established project phases and corresponding project management activities greatly increases their usefulness. This is particularly true in the construction industry, where project teams need access to best practices and lessons learned as they coordinate drawings in pre-constructions, prepare bid packages, review submittals, and other project phases.

### SUMMARY

In general, in one aspect, the invention relates to a computer-based method for organizing a knowledge management platform to gather and share knowledge learned by construction project teams. The method includes authorizing access to the knowledge management platform, wherein the knowledge management platform comprises an integrated organizational scheme for organizing a construction project into one or more project elements, facilitating input of project data into the knowledge management platform and storing project data based on the integrated organizational scheme, wherein project data comprises the knowledge learned by construction project teams, linking project data to one or more project elements in the integrated organizational scheme to obtain content, and presenting the content to user computers responsive to a request submitted to the knowledge management platform.

In general, in one aspect, the invention relates to a system for organizing a knowledge management platform to gather and share knowledge learned by construction project teams. The system includes a user interface operatively connected to user computers, a server that is communicatively connected to user computers, and an authorization module, a content management module, and a project data repository, all of which are operatively connected to the server. The server is configured to receive project data. The authorization module authorizes access to the knowledge management platform, wherein the knowledge management platform comprises an integrated organizational scheme for organizing a construction project into one or more project elements. The content management module facilitates input of project data into the knowledge management platform, wherein project data comprises the knowledge learned by the construction project teams, and links project data to one or more project elements in the integrated organizational scheme to obtain content. The user interface presents the content to at least one of the user computers responsive to a request submitted to the knowledge management platform. The project data repository stores project data based on the integrated organizational scheme.

In general, in one aspect, the invention relates to a computer readable medium storing instructions for organizing a knowledge management platform to gather and share knowledge learned by construction project teams. The instructions include functionality for authorizing access to the knowledge management platform, wherein the knowledge management platform comprises an integrated organizational scheme for organizing a construction project into one or more project elements, facilitating input of project data into the knowledge management platform and storing project data based on the integrated organizational scheme, wherein project data comprises the knowledge learned by the construction project teams, linking project data to one or more project elements in the integrated organizational scheme to obtain content, and presenting the content to user computers responsive to a request submitted to the knowledge management platform.

### BRIEF DESCRIPTION OF THE DRAWINGS

FIG. 1 shows a diagram of a system in accordance with one or more embodiments of the invention.

FIG. 2 shows a flow chart in accordance with one or more embodiments of the invention.

FIGS. 3-10 show a variety of user interfaces in accordance with one or more embodiments of the invention.

FIG. 11 shows a diagram of a computer system in accordance with one or more embodiments of the invention.

### DETAILED DESCRIPTION

Exemplary embodiments of the invention will be described with reference to the accompanying figures. Like items in the figures are shown with the same reference numbers.

In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In one or more embodiments of the invention, the present invention is implemented as a web-based knowledge-sharing platform. In one or more embodiments of the invention, the knowledge-sharing tools are displayed in an interactive online environment that allows users to edit content and/or add new content based on the user's experiences. The knowledge-sharing tools organize captured knowledge within a structured, intuitive format that facilitates efficient locating of relevant information. Content, such as lessons learned and best practices, is organized into categories that are routinely used in the industry. In one or more embodiments of the invention, knowledge may be shared through tools that project teams routinely use to manage projects (e.g., checklists, meeting agendas, and organizational formats such as Construction Specifications Institute (CSI) MasterFormat®, project phase, and checklist type). The CSI MasterFormat® is described at www.csinet.org, including MasterFormat™ 2004, and that information is incorporated herein by reference. CSI format is a well known standardized format for providing construction project information. MasterFormat is a registered trademark of CSI.

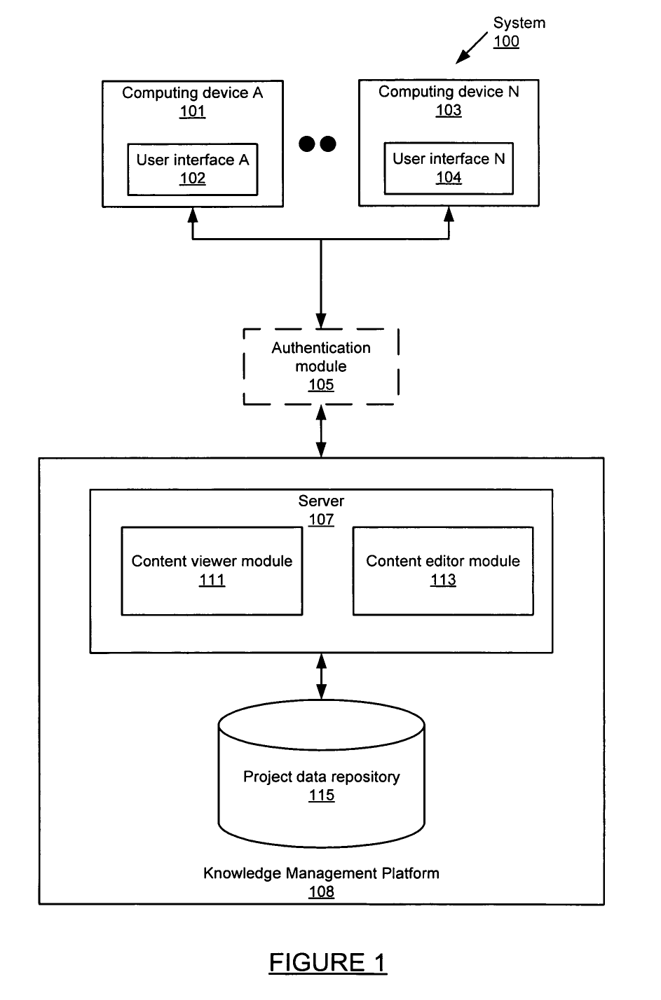

FIG. 1 shows a diagram of a knowledge management platform (108) in accordance with one or more embodiments of the invention. As shown in FIG. 1, the system (100) includes one or more user computing devices (e.g., computing device A (102) and/or computing device N (103)), a server (107), a content viewer module (111), a content editor module (113), and a project data repository (115). Each is described below.

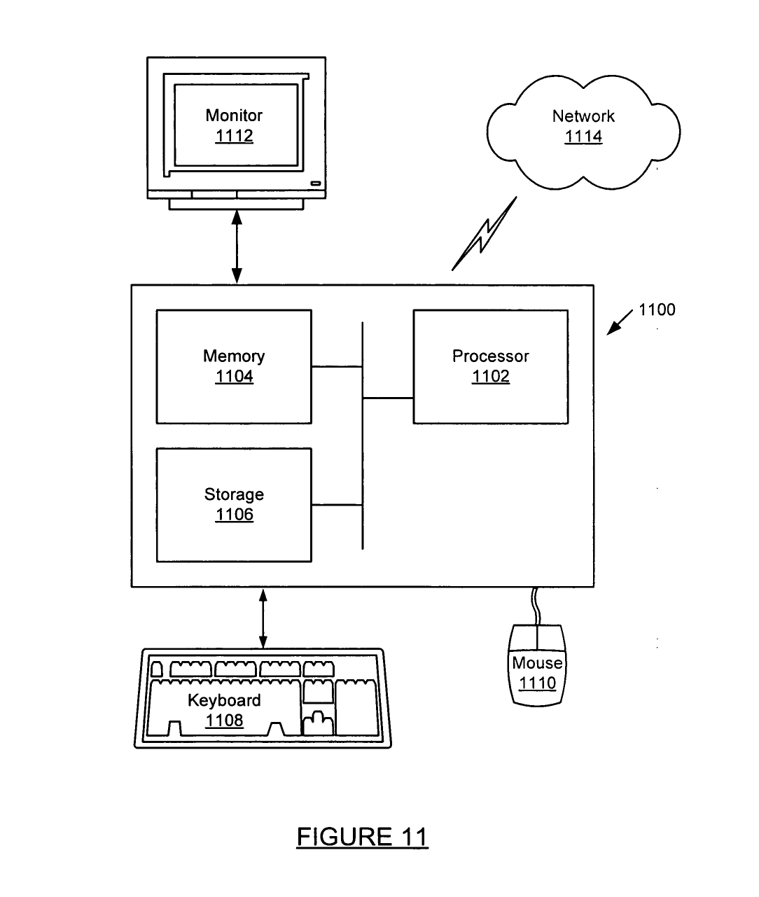

In one or more embodiments of the invention, the computing device (e.g., computing device A (102) and/or computing device N (103)) may be used by a project team member, management, or someone authorized by the project team to participate in project team knowledge sharing and management. The computing device (e.g., computing device A (102) and/or computing device N (103)), as described below in FIG. 11, includes functionality to obtain input from one or more user computers and/or receive project elements and data, send a modification or modification request, display content, and receive a notification (e.g., that a section of interest has been modified) pursuant to user preferences. Both the input and output from the computing device (e.g., computing device A (102) and/or computing device N (103)) may be presented (e.g., displayed) on the computing device (e.g., computing device A (102) and/or computing device N (103)) and/or viewed by the user for some period of time.

As used herein, “user computers” or “user computing devices” encompass all computing devices with access (direct or indirect) to the knowledge management platform. While, in one or more embodiments, data (regarded as knowledge) is input by members of the construction project teams using one or more computing devices, the content of the knowledge management platform may be presented to all user computers or user computing devices. For example, following the input of the data by the members of the construction project teams, knowledge may be presented to construction project teams, corporate management, outside contractors or professionals, government inspectors, collaborating companies, etc.

As used herein, the term “project elements” includes topics or categories related to the organizational structure of the knowledge management platform (108). A detailed description of that organizational structure is provided below, however, in summary, the content is organized into at least two levels, a top and secondary level, and within these levels the content is further organized into project elements, including tools designed to correspond to certain project phases. In one or more embodiments of the invention, clients may adapt the knowledge management platform (108) to modify the project elements and may also allow users to add, edit, or delete (“modify”) these project elements. For example, this application uses the category of “waterproofing” to describe the invention. However a user or client may opt to remove this project element if it is outside the company's offered services. In one or more embodiments of the invention, all content (e.g., project data, project elements, modifications) must be approved or entered by a designated administrator.

As used herein, the term “project data” includes information related to one or more project elements that is submitted by a user. In one or more embodiments of the invention, project data may be entered directly into the existing content (e.g., checklist) of the knowledge management platform (108). Alternatively, in one or more embodiments of the invention, project data must first be reviewed and accepted by one or more site administrators before it is incorporated into the existing or “baseline” content. Project data may be solicited by the knowledge management platform (108), for example, using topic-specific questions. Alternatively, users may add project data without such prompting. Project data may include, for example, additional checklist items, project information, subcontractor information, lessons learned about project management topics (e.g., how to start up or close out a project), experts for technical topics, and the like.

As used herein, the term “construction” refers to physical improvements to a site or to an existing structure, involving a building or other civil infrastructure, including, for example, bridges, roads, railways, dams, sewers, etc.

In one or more embodiments of the invention, the project elements, project data, notifications, submitted modifications, and knowledge-sharing tools are displayed on a computing device (e.g., computing device A (102) and/or computing device N (103)) using a user interface (e.g., 102, 104), such as a graphical user interface (GUI). The user interface (e.g., 102, 104) may be configured to allow entry of data using, for example, data entry fields or a “floating note” format (until approved by an administrator) and in a multitude of formats, such as graphics, text, digital images, multimedia, etc.

In one or more embodiments of the invention, the server (107) is configured to transmit and receive information from the computing device (e.g., computing device A (102) and/or computing device N (103)), for example, using a secured network or other means to limit accessibility to such information, and validate the identity of the user.

The server (107) may be a networked computer system, such as shown below in FIG. 1. The server (107) may receive, send, modify, arrange for storage of, and/or otherwise process content and/or associated project data. The server (107) may also provide additional functionality necessary to perform the invention. For example, the server (107) may interact with a network controlled by a project team, an employer of the project team, a building owner, or a client to which the project team provides project updates and reports. In one or more embodiments of the invention, the server (107) may interact with a local authority, an inspector, or any other authority that validates or reviews a construction company's project records. In one or more embodiments of the invention, the server is a web server (e.g., Microsoft Internet Information Server (IIS)®). Microsoft Internet Information Server (IIS)® is a registered trademark of Microsoft Corporation.

Further, the server (107) may be linked to an existing intranet or internet portal allowing access by all authorized users. For example, the server may be accessed via the company (or third party) portal by project team members, independent contractors (e.g. designers, architects, contractors), or others involved in the project.

The project data repository (115) may support the storage needs of the server (107) and other components necessary to provide functionality to perform the invention. In one or more embodiments of the invention, the project data repository (115) is a device capable of storing information and retrieving the stored information by interacting with or independently of the server (107). The project data repository (115) may be, for example, one or more magnetic storage devices, optical storage devices, flash memory, or other similar devices. In one or more embodiments of the invention, the project data repository (115) is able to index the stored information by various attributes (such as a source of data or edit, time data or edit received, time data or edit approved, identity of approver, user ratings of content, notification requirements associated with data, or other identifiers associated with data). In one or more embodiments, the project data repository (115) may store updated content as it is modified or added by the users. In one or more embodiments of the invention, an administrator can specify operational parameters for storing data and making it available to users.

In one or more embodiments of the invention, all or a portion of the project data repository (115) resides on the server (107) associated with content viewer module (111) and content editor module (113). In one or more embodiments of the invention, all or a portion of the project data repository (115) resides on a server (not shown) associated with the project team members, e.g. a structured query language (SQL) server. In one or more embodiments of the invention, all or a portion of the project data repository (115) resides on a third party server. For example, the third party server may be associated with a general contractor, designer, project management agents, etc. In one embodiment of the invention, content stored in the project data repository (115) may be retrievable with a search engine (not shown).

While the invention has been described with a single project data repository (115), one skilled in the art will appreciate that multiple project data repositories may be used to hold all data associated with the server (107), content viewer module (111), content editor module (113), and/or other component necessary to perform the invention. Likewise, while the project data repository (115) is depicted as centralized, multiple databases may hold the data in various combinations. Further, the project data repository (115) may include data protection and security schemes to protect sensitive data from corruption, theft, attack, destruction, and other forms of intrusion and loss of integrity.

In one or more embodiments of the invention, the system includes a content editor module (113). The content editor module (113) is configured to accept project data from users (e.g., project team members, contractors, etc.) and transform it into rich content. In this context, rich content (or rich media) means to present content using multimedia, such as, for example, text, images, video, audio, and other multimedia types. In one or more embodiments of the invention, the rich content is presented and stored in HyperText Markup Language (HTML) format. In one or more embodiments of the invention, the content editor module (113) comprises an HTML editor, for example, a WYSIWYG (what you see is what you get) program (e.g. FrontPage®, PageMill®, Mozilla Editor) that allows a developer to see what the end result will look like while the interface or document is being created. FrontPage® is a registered trademark of Microsoft Corporation. PageMill® is a registered trademark of Adobe Systems, Inc.

In one or more embodiments of the invention, the content editor module (113) allows users to directly add project data and/or modify content. Modifying content may take many forms. For example, a user may use the organizational scheme to locate a content concerning technical topic of interest, and enter a comment or upload a file relating to the content. In one or more embodiments of the invention, the user comments are displayed as floating notes or attached files. In one or more embodiments of the invention, the content editor module (113) may track which users submitted particular content (including comments or modifications to baseline content). In one or more embodiments of the invention, all proposed changes to baseline content (e.g., adding project data, modifications, comments, or floating notes) must first be reviewed and approved by one or more administrators. For example, an administrator may act as a gatekeeper, reviewing the appropriateness of input and verifying that it is properly categorized.

In one or more embodiments of the invention, the content editor module (113) comprises a webpage. For example, content may be displayed as web pages (examples are discussed below). It is also possible to link files (or other web pages) to the content.

In one or more embodiments of the invention, the content editor module (113) may be configured to track the progression of the project, forecast needs for particular content and at a particular project phase, and solicit project data from users as required by the project. The process used to solicit project data from users is discussed below.

In one or more embodiments of the invention, the content editor module (113) may track edits to a particular section and the server may notify a user of the submitted or accepted content modification or addition of project data. The form of that notification may vary, including using, for example, electronic mail, SMS or MMS texting, audio messaging, or interactive voice response (IVR) system. In one or more embodiments, users may set personal preferences for notifications of content revisions or additions and these notifications may be as granular as desired.

In one or more embodiments of the invention, the content editor module (113) may allow users to export content. For example, users may select what checklist topics they wish to aggregate and export to particular file formats (e.g., .xls, .doc).

The content viewer module (111) is configured to present specific content from the project data repository. Content may be organized into two levels. At the top level, there are at least two categories: best practices topics for project management and technical content topics, for example, following the CSI MasterFormat (an industry classification system referred to above). At the secondary level, the collected data is shared through knowledge-sharing tools designed to correspond to certain project phases (e.g., constructability review, buy-out, submittal review, field quality control, commissioning, close-out, etc.). The knowledge-sharing tools can take many forms, including, for example, checklists, category lists, meeting agendas, action items, e-mails, text messages, voice messages, and the like. The content may be displayed, via a user interface (e.g., 102,104), based on the relevant phase of the construction project (see examples provide above). In one or more embodiments of the invention, the content is displayed as HTML.

In one or more embodiments, the content viewer module (111) may be pre-configured with a set of best practices categories and checklists for technical content areas (e.g., design coordination checklist, best practices, instructions to bidders, submittal review checklist, pre-task checklists, quality control, permits and inspection, commissioning and close-out, etc.). In one embodiment, modular information architecture is used, so that knowledge-sharing tools can be added piecemeal if desired. For example, a client can initially implement a few tools in a navigation bar and add others later. This facilitates gradual deployment of the system, if desired.

In one embodiment, the system (100) is implemented as a platform to gather and share knowledge within a company (similar to an intranet). In addition, if desired, users can share their knowledge sharing platform with others involved in the project. For instance, an owner of a building may decide to make his or her content available to their designers, general contractors, and subcontractors. Alternatively, general contractors who are not direct competitors may decide to share their content.

In one or more embodiments, the system (100) can be deployed on an existing intranet or it can be implemented as a stand-alone website. Other platform options include, for example, ASP.Net®, Java®, and/or document management systems. It can be implemented using any available architecture, including, for example, a wiki platform, a web-based application platform, a desktop or client/server application, a stand-alone database, a distributed architecture, or the like. The content viewer module (111) and content editor module (113) may be stand-alone applications operating on a user's computer or may be a web-based applications accessible using a web browser. In some cases, the content viewer module (111) and/or content editor module (113) may include a combination of stand-alone and web-based features. For example, a stand-alone application may be configured to communicate with a back-end server providing shared services to multiple instances of the content viewer module (111) and/or the content editor module (113). ASP.net is a registered trademark of Microsoft Corporation. Java is a registered trademark of Sun Microsystems, Inc.

In one or more embodiments of the invention, the system includes an authentication module (105). The authentication module (105) is configured to authenticate a user's right to access the system, for example, by requiring a unique user name and password. For example, access to the authentication module (105) may require authentication using a password, one or more secret questions, a personal identification number (PIN) unique to the particular user, and/or any other processes or network architecture necessary to prevent or restrict access by unauthorized parties. The authentication module (105) is a security system that allows users to be identified and assigned authoring and reading rights (e.g., Microsoft Active Directory®). The authentication module (105) may be hosted by the server (107), or by a linked system, for example, an existing company intranet or internet website. Microsoft Active Directory® is a registered trademark of Microsoft Corporation. In one or more embodiments, the project data repository (115) is located in a local area network (LAN) and the authentication module (105) includes a firewall protecting the LAN from unauthorized access.

The system (100) can be a stand-alone platform, or it can be linked to an existing intranet portal and/or integrate with existing systems such as, for example, Microsoft Office SharePoint Server 2007®, Open Text Corporation LiveLink®, IBM WebSphere®, and the like. In one or more embodiments of the invention, the content viewer and/or content editor modules (111, 113) can exchange data with other software applications, including, for example, project management applications (e.g., Prolog, Primavera Expedition®, etc.), estimating applications (e.g., Timberline®, etc.), Building Information Management (BIM) systems, and Geographic Information Systems (GIS®) Microsoft Office Share Point Server 2007® is a registered trademark of Microsoft Corporation. Open Text Corporation Livelink is a registered trademark of Open Text Corporation. IBM Websphere is a registered trademark of IBM Corporation. Primavera Expedition is a registered trademark of Primavera Systems. Timberline is a registered trademark of Sage Software, Inc. GIS is a registered trademark of Environment Systems Research Institute, Inc.

Method for Organizing a Knowledge Management Platform

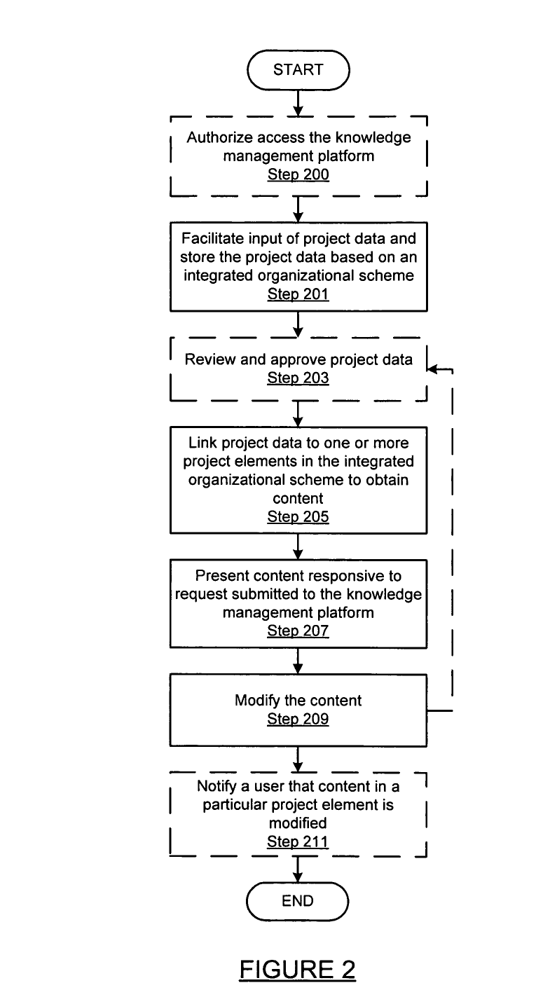

FIG. 2 shows a flow chart for organizing a knowledge management platform to gather and share knowledge learned by construction project teams in accordance with one or more embodiments of the invention. In one or more embodiments of the invention, one or more steps shown in FIG. 2 may be omitted, repeated, and/or performed in a different order than the order shown in FIG. 2. Accordingly, embodiments of the invention should not be considered limited to the specific arrangement of steps shown in FIG. 2.

In addition, those skilled in the art will recognize that certain steps may precede those shown in FIG. 2. For example, the project team may first install baseline content modules (e.g., general content created by a third party that may be customizable), a site administrator may create initial content (e.g., through text editor) and/or migrate and parse existing documents (paper or electronic) into the platform (e.g., copy and paste through a test editor), a user may first access a company intranet, indicate the name or identifying information of a particular topic, enter data concerning the checklist of the particular topic, navigate the user interface to a particular category of interest, review a note or information request displayed on the user interface, upload an electronic or scanned document to the product data repository.

Authenticating Right to Access

In one or more embodiments of the invention, as shown in Step 200, the system authorizes access (e.g., authenticates a user's right to access) the knowledge management platform. Specifically, the authentication service may be configured to ensure that only authorized users are given access to the knowledge management platform. For example, users may be required to present a username and/or password, an encrypted digital signature, or any other type of authorization credential recognized as valid by the authentication system. In one or more embodiments, only site administrators may be authorized (or given the access privileges necessary) to make or allow changes to baseline content.

In one or more embodiments, user authentication procedures may further allow the system to track the source of, and project data and/or modifications submitted by, a particular user (or user group) during each session. For example in one or more embodiments of the invention, comments to existing content may be displayed as “floating notes.” The identification of the user may be displayed along with the project data and/or modifications made or proposed by that user. In addition, in one or more embodiments, a team member may request a notification, for example, based on the identity of the user who enters key project data. Also in one or more embodiments, knowing the source of all submitted project data and modifications could facilitate the administrator's job of assuring that content complies with company policies and any applicable regulations. For example, the client may have a policy that comments posted by an “expert” in a particular topic area, or a project supervisor, may be more reliable than those posted by the average user.

Integrated Organizational Scheme

In one or more embodiments, as shown in Step 201, the knowledge management platform facilitates input of project data from the user and stores project data based on an integrated organizational scheme. Project data may be obtained from individual construction project teams members, and may be aggregated using the knowledge management platform to create content representing the knowledge of numerous construction project teams. In one or more embodiments of the invention, content is organized into different layers. At the top level, there are at least two categories: best practices topics for project management and technical content topics, for example, following the Construction Specification Institute (CSI) MasterFormat® (an industry classification system). In one or more embodiments, an “Add Your Input” category is also part of the top level.

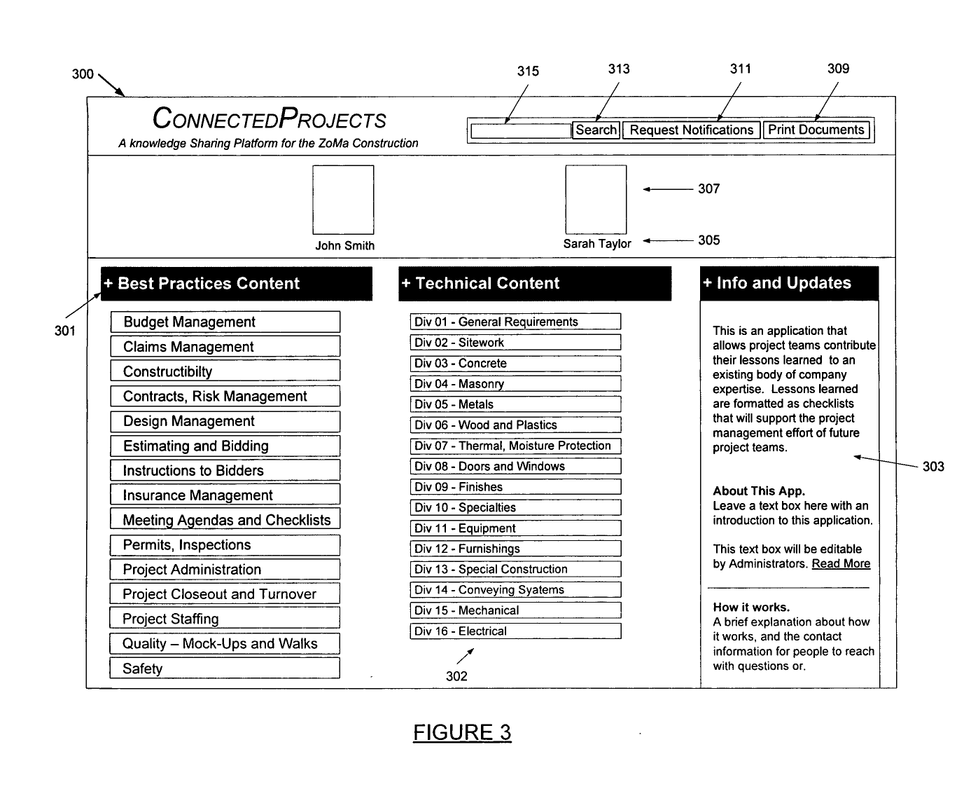

For example, FIG. 3 shows an example of a home page (300) displaying the three categories: best practices content (301), technical content in CSI format (302), and Info and Updates (303). In one or more embodiments, users may access particular project elements and create content using all three of these categories. In one or more embodiments, team member names (305), multi-media representations (307) (e.g., photo, icon), and related links (not shown) may be included to facilitate user navigation and experience.

In one or more embodiments, as shown in FIG. 3, best practices topics (301) may be arranged according to construction project phases. Content in this section includes, for example, information from lessons learned meetings with project teams, including meeting minutes, company procedures, standards, and any other documents that a client wishes to make accessible to users and subject to user input.

In one or more embodiments, as shown in FIG. 3, technical content (302) may be arranged in various organizational formats, including CSI MasterFormat®. The lessons learned for the technical content (302) may be structured as knowledge-sharing tools (e.g., checklists, category lists, meeting agendas, action items, e-mails, text messages, voice messages) that mirror project phases and the corresponding project management activities. In one or more embodiments, administrators can set up and populate additional checklists to meet the needs of their particular organization. Users can enhance these tools by providing input based on their own experiences.

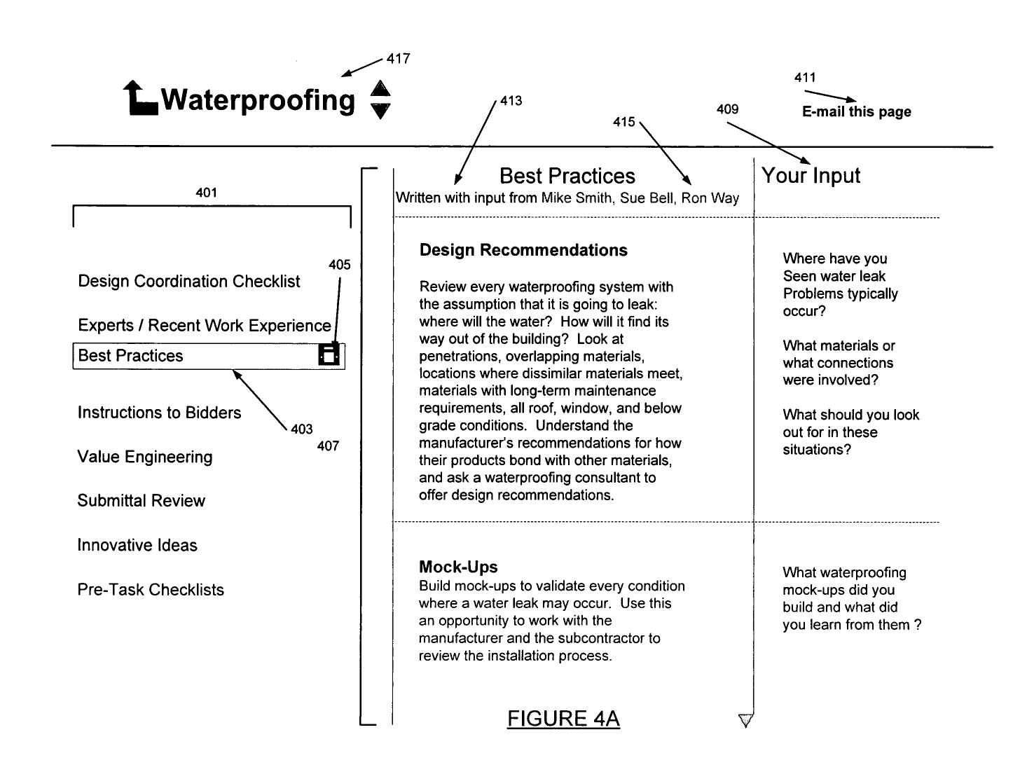

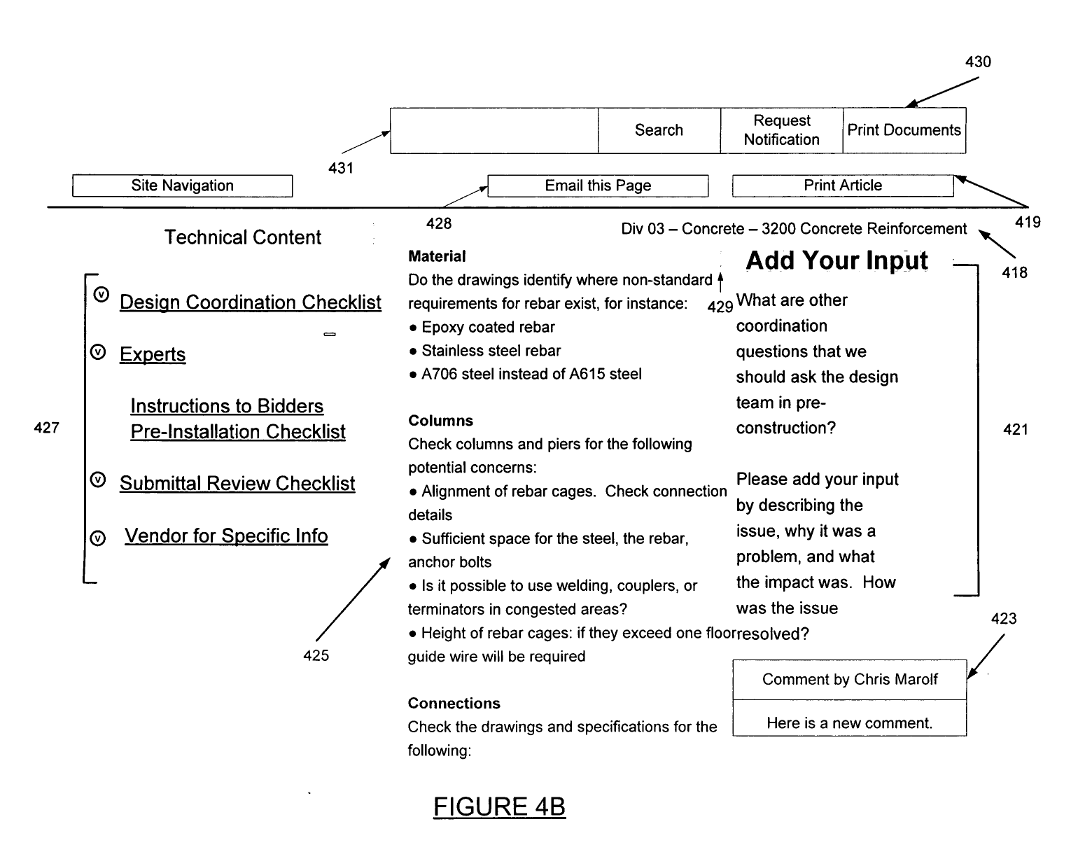

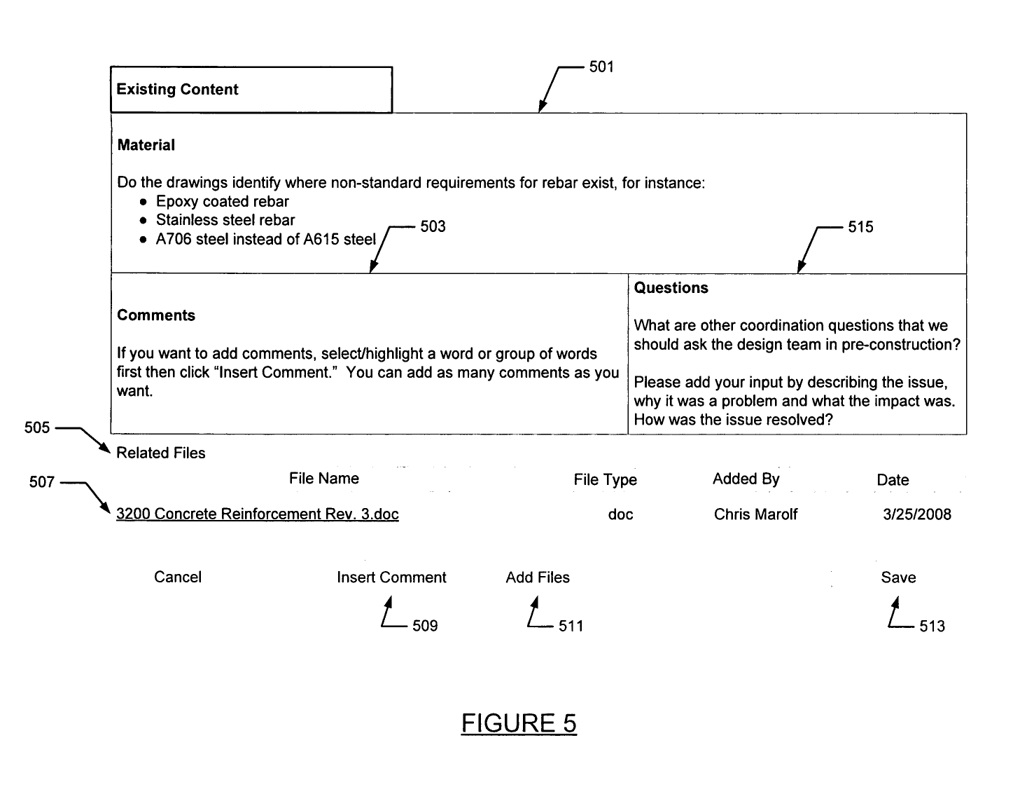

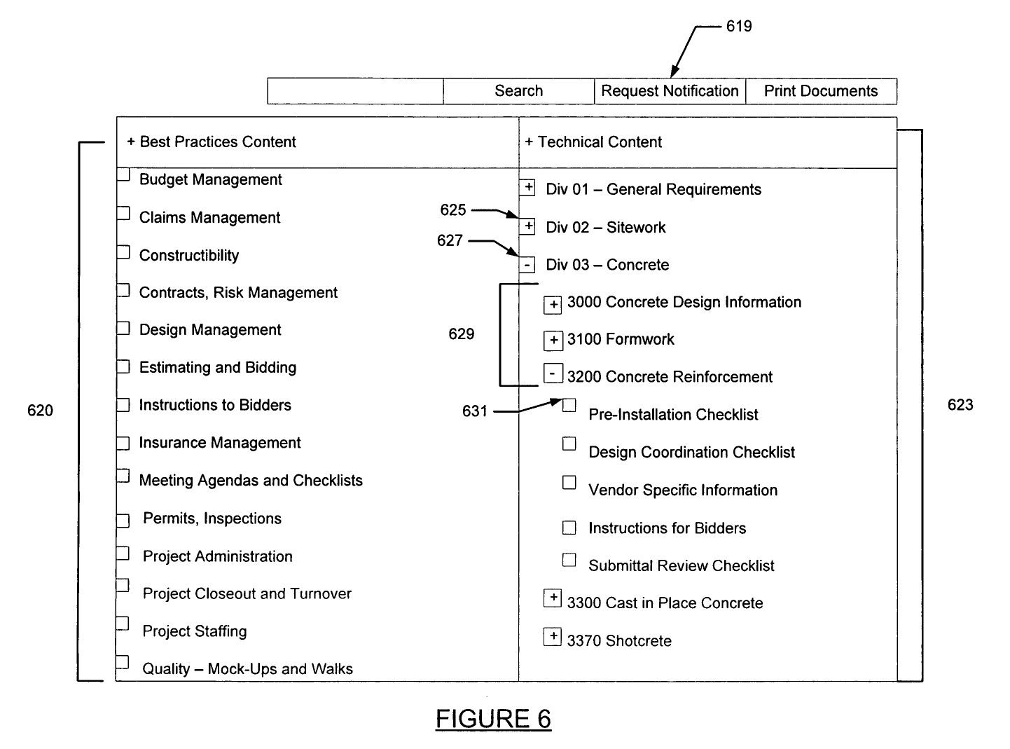

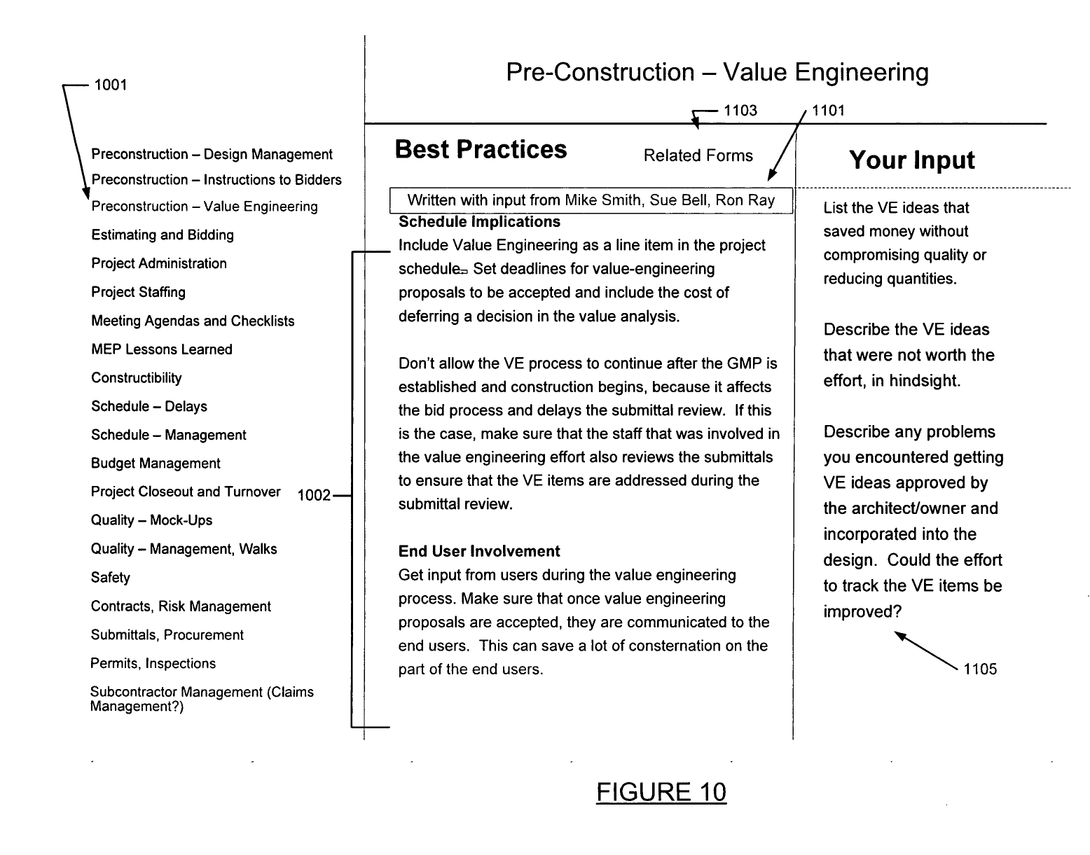

There may be different project elements for the best practices content (301) and technical content (302) categories, including, for example:
a. Best Practices (shown in FIG. 4A, 4B), which include articles that compile lessons learned and recommendations about a technical topic (e.g., elevator construction) or a project management topic (e.g., working in occupied buildings), typically organized by project phase.
b. Design Coordination Checklist (shown in FIG. 5), which includes a checklist with questions intended to ensure the plans are coordinated between the different design disciplines (e.g., electrical, plumbing, structural, etc.) and to ensure that the details are workable and will not lead to construction defects; often used during pre-construction phase when plans and specifications are being finalized.
c. Expert List (shown in FIG. 6), which includes a list of in-house or outside individuals or entities who are very knowledgeable about a certain topic, along with their contact information, typically organized in the CSI MasterFormat®.
d. Value Engineering (VE) (shown in FIG. 10), which includes a review process in which the project team members look for ways to reduce the project cost while maintaining the original functionality of the building.
e. Submittal Review, which includes a process in which subcontractors submit product information and shop drawings (a submittal) to show how they will install their work, and the design team reviews the submittal to ensure it meets the contractual requirements as set forth in the plans and specifications.
f. Instructions to Bidders, which includes instructions prepared by general contractor to tell prospective subcontractors what they should include in bids, because it may be not clearly identified in the plans and specifications, or because the scope responsibilities need to be more clearly delineated between subcontractors.
g. Innovative Ideas, which includes one or more individuals or entities (e.g., employee, consultant, etc.) suggestions that improve the way buildings are built because they save time or money, or because they increase the quality.
h. Pre-task Checklists, which include checklists that subcontractors and contractors use on a jobsite before starting work to ensure the right people are involved, the right tools are in place, the proceeding work is complete, and the desired outcome is understood.
i. Quality Control Checklist, which includes checklists that subcontractors and contractors use on a jobsite before starting work to ensure that sources for poor workmanship or construction defects have been identified and corrective actions have been planned.
j. Permit and Inspection Checklist, which includes a checklist with questions intended to identify what permits should be considered for each scope of work and what inspections are required during and after installation from the regulatory agencies.
k. Sustainable Construction Checklist, which includes a checklist with questions intended to suggest environmentally friendly building methods or products during the design and construction of a project.
l. Closeout and Commissioning Checklist, which includes a checklist with questions intended to ensure that equipment (generators, motors, etc.) and building systems (HVAC, plumbing, etc.) are properly started up, tested, adjusted, and coordinated with each other at the end of a project.
m. Safety Checklist, which includes a checklist for field personnel with questions to ensure that they are taking the necessary precautions and have the tools and equipment in place to work safely.
n. Additional project elements may be added as the need or requirement exists.

A user may access particular project elements of interest using the technical or best practices content framework. At the secondary level, the present invention seeks to collect all company knowledge about a certain topic in one location and make it accessible through different knowledge-sharing tools routinely use to manage projects in pre-construction and construction phases. In one or more embodiments of the invention, the presentation of content at this secondary level includes: knowledge sharing tools, content, and topic-specific questions to solicit feedback. Clients (or site administrators) can customize and/or add new knowledge sharing tools, or edit the names of the above categories. Those skilled in the art will recognize that the organization and presentation of content may take many forms without deviating from the scope and spirit of the present invention.

Inputting Project Data

Project data may be added to the knowledge management platform created in a number of ways. For example, users can populate the system with new content and/or existing content that has been appropriately reformatted. In one or more embodiments of the invention, users can purchase baseline content with existing checklists and tools to populate their application and customize this baseline content as required. In one or more embodiments of the invention, existing documents (e.g., electronic or hard copies) may be migrated and parsed into the knowledge management platform. In one or more embodiments of the invention, users may provide project data using audio means (e.g., voice recorder, transcription service).

In one embodiment, users may subscribe to a service that updates the checklists remotely. For example, in a situation where users (e.g., not in direct competition) agree to share new lessons learned or best practice, updates may be made externally by user A, then user A's updated checklist shared (via subscription service) with user B. In one or more embodiments an administrator initially reviews and accepts external suggestions prior to inclusion in baseline content.

In one or more embodiments, users may be guided to add project data using a set of topic-specific questions. For example, FIG. 4A shows a page displaying Best Practices content (407) under the subsection “Waterproofing” (417). In one embodiments, users may download (to print or save) content by clicking on an icon (405), or mail e-mail content using a link (411). The authors of the content in this section are provided (413), and links (e.g., 415) may be provided, for example, to contact an author or view his or her project history list and other information. In one or more embodiments, topic-specific questions relevant to each content section may be provided in an “Add Your Input” section (409).

Similarly, as shown in FIG. 4B, project data for technical content may be solicited using topic-specific questions or “Add Your Input” functions. Topic specific questions are intended to help users provide meaningful feedback by inquiring about, for example, root causes of a problem, coordination issues, or other impacts associated with a problem. In one or more embodiments, these questions may be customized or edited by a site administrator.

In one or more embodiments, as shown in FIG. 4B, a user may access a section of interest, e.g. “Div 03—Concrete—3200 Concrete Reinforcement” (418). In one or more embodiments, if the information sought is not immediately found, a user may try using a key word(s) search (431). In that section, knowledge-sharing tools (checklists, sample instructions) (427) may be provided along with topic-specific articles (425). In one embodiment, users may print or download existing content (419) or linked documents (430) to various file formats (e.g., .doc). In one or more embodiments, an “Add Your Input” link (421) with topic-specific questions solicits input from users.

In one or more embodiments, project data may take the form of comments (423) or “floating notes.” For example, if a user wished to comment on the article (425) in FIG. 4B, he or she could use an “Add Your Input” link (429) that would take the user to another web page (e.g., a comment page).

In one or more embodiments, as shown in FIG. 5, the comment page may include existing content (501) from a topic-specific article and topic-specific questions (515) intended to guide user comments. Instructions (503) may be provided, for example a user may be directed to highlight a word or section first and then click “Insert Comment” (509). In one or more embodiments, users may add project data in the form of electronic files (511), and other users may access these files using, for example, a link (507).

Returning to FIG. 4B, in one or more embodiments, a user may request a notification (433) if project data is added (or content modified) in a particular section. As discussed above, the generation of notification requests and form of the notification may vary. For example, if a user selects a request notification button, he or she may be taken to a webpage like that shown in FIG. 6. In one or more embodiments, the categories, Best Practices Content (620) and Technical Content (623), may be displayed using an expandable pull-down menu. For example, “+” boxes next to the CSI division (625) may indicate that sections for that division exist and, when the user clicks on the “+” box, the “+” becomes a “−” (e.g., 627), and sections (e.g., 629) may be displayed. The same process may be used to explore subsections (613).

In one or more embodiments of the invention, the knowledge management platform can capture lessons learned. For example, input links and topic specific questions allow a company to collect lessons learned by a project team online in a structured and retrievable format, without conducting a traditional meeting. In one or more embodiments, users may create content by modifying web pages and uploading digital files. In one or more embodiments of the invention, users may create content by creating a voice recording. For example, when the user clicks on a “voice recording” button, the knowledge management platform may initiate a call to the user's mobile phone, the user records a message using the mobile phone, and the recording is saved to a web page as an audio file or converted to text through a transcription service. Those skilled in the art can appreciate that content may be captured using many techniques, now known or later realized, without deviating from the spirit of this invention.

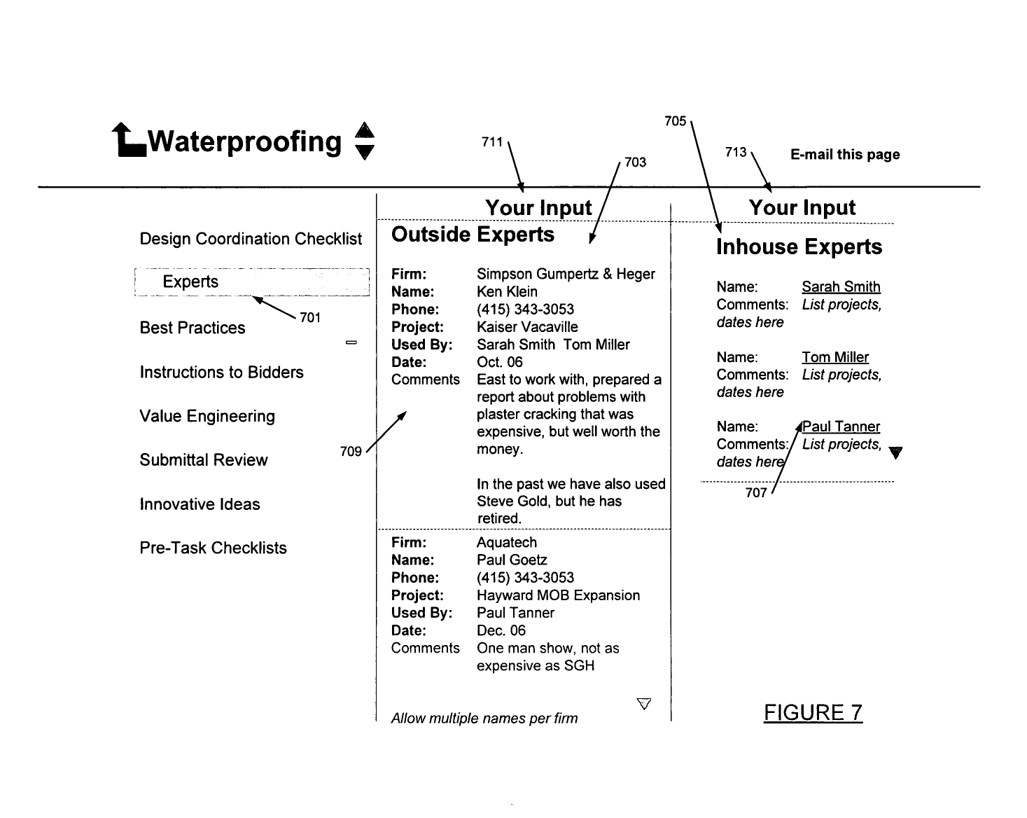

In one or more embodiments of the invention, user input may be solicited to update general information. For example, as shown in FIG. 7, users may input expert data using an “Add your input” link (e.g., 711, 713, 707). In one embodiment, every page features the “Add Your Input” link.

Returning to FIG. 2, in one or more embodiments of the invention, as shown in Step 203, an administrator may act as a gatekeeper, reviewing the appropriateness of input project data, verifying that it is properly categorized, and approving project data if the data is deemed appropriate and properly verified. For example, the site administrator may evaluate the reliability of the information based on the source of the project data (e.g., a company supervisor or third party subcontractor), or analyze the project data to ensure that it complies with company policies and legal requirements. Clients and/or administrators can adjust the restrictiveness of this review process, including who reviews the content or what content needs to be reviewed, and/or designate one or more site administrators for different subject matters or areas. In one or more embodiments, project data may be displayed as “comments” or “floating notes” and may include the name of the author. A variety of method may be used to ensure that administrators may review and approve the project data before it is included in the approved baseline content and published.

Project Data to Organizational Format

In one or more embodiments of the invention, as shown in Step 205, project data submitted by a user is linked to one or more project elements in an integrated organizational scheme to obtain content. For example, as has been discussed above, project data (e.g., comments, documents, audio files, and web pages, directed to a particular article) will be linked to the content in that topic. In addition, in one embodiment, the identity of the user who submitted the project data will be linked to the project data and may also be available to users viewing the submitted content. In one or more embodiments, project data may be linked to particular projects and/or project milestones.

Present Content

In one or more embodiments of the invention, as shown in Step 207, content is presented to a plurality of user computers using the integrated organizational scheme described above. A user seeking to access content may do so by presenting a request to the knowledge management platform. The form of the request may vary. For example, a user may request access to content of interest using links arranged according to the integrated organizational scheme, a keyword search query, function buttons, scroll-down or pop-up menus, icons, navigation tools, mobile device functions, etc. Those skilled in the art will appreciate that many different methods of requesting access to data exist, and the request function may take other forms now known or later discovered.

An example of a user request is shown in FIG. 3. In one or more embodiments, users may find content in the knowledge management platform using a search function (313) (e.g., keyword search (315)). In one or more embodiments, the search will access all content in the knowledge management platform. In one or more embodiments, the search may be more focused. For example, the user may restrict the search to a particular project element, tool (e.g., submittal review checklist), CSI division (or sub-categories), or project management category. Alternatively, in one or more embodiments, a user may request that the knowledge management platform present content by sending an electronic document to, for example, the user's e-mail address. Numerous other examples of user requests for content are provided herein.

Allowing Users to Modify Data

Returning to FIG. 2, in one or more embodiments of the invention, as shown in Step 209, users may modify the baseline content in a variety of ways (e.g., edit checklists and articles, update project and expert information, etc.). The methods used to allow users to modify content may be the same or similar to those used to add project data. As with project data, in one or more embodiments of the invention, modifications may be subject to review and acceptance by a site administrator before they will be displayed as content.

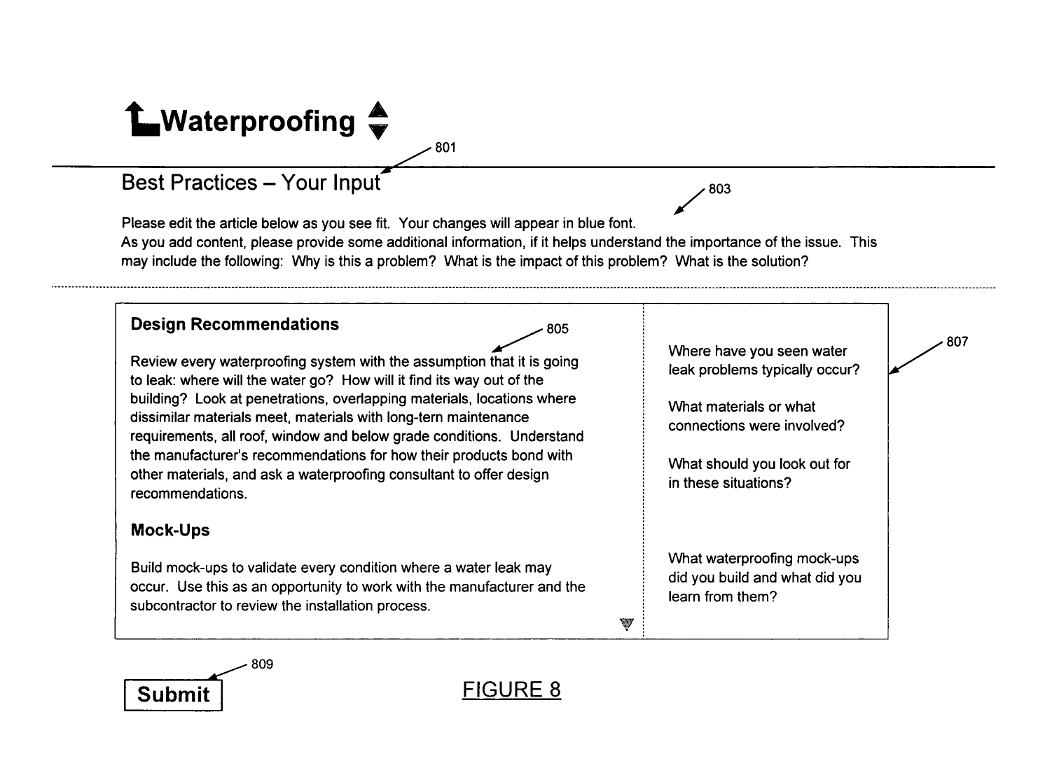

For example, FIG. 8 shows a Best Practices article (805) related to the subsection “Waterproofing.” Instructions (803) guide the user regarding how to edit the article. In one or more embodiments, for example, the changes may appear in blue font. The instructions (803) and/or topic-specific questions (807) may direct the user's modifications to make them more useful and complete. Once modifications are completed, the user may “Submit” (809) or “Save” (not shown) them. In one or more embodiments, an administrator may review the modifications before they are displayed to other users and/or otherwise included in the baseline content (e.g., no longer displayed in blue font).

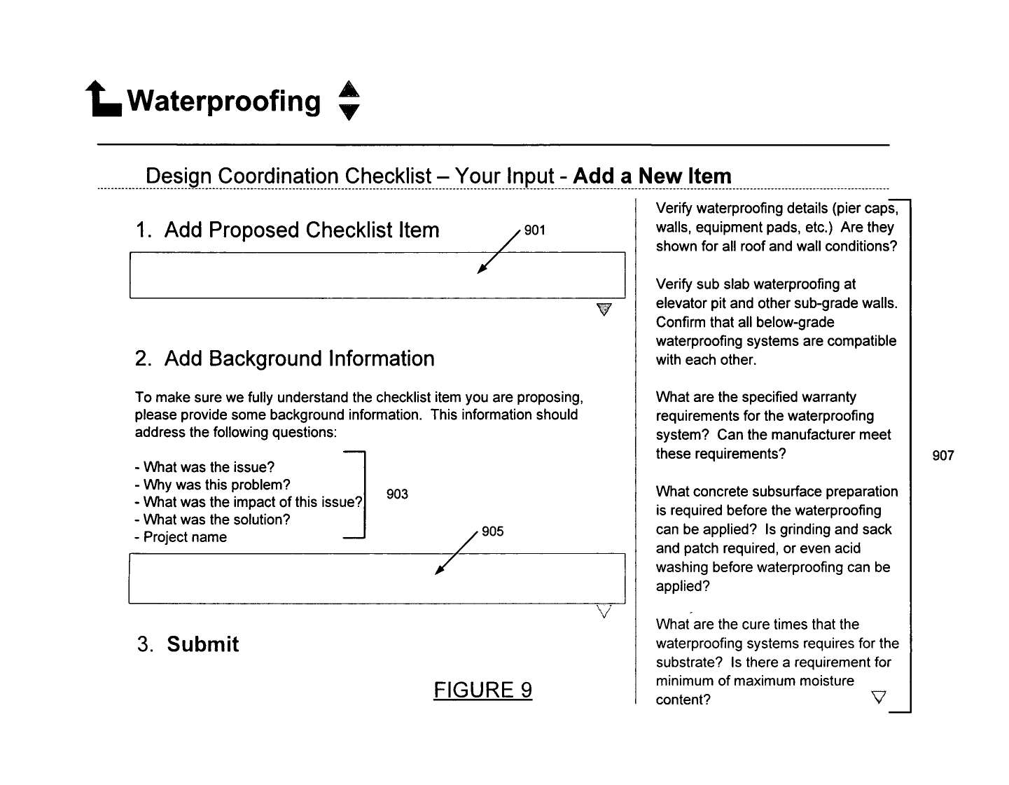

In one or more embodiments of the invention, as shown in FIG. 9, users may modify checklists by entering proposed checklist items into a data field (901). In one or more embodiments, the checklist being edited (907) will be displayed on the same page. Here, again, topic-specific questions or general pointers (903) may be used to elicit a more complete and useful response (e.g., in the form of background information (905)).

In one or more embodiments of the invention, users may modify any existing content by making edits, comments, deletions, and/or changes. In one or more embodiments of the invention, a site administrator reviews and approves the modified content before it is displayed to all users.

Additional Ways to Capture Knowledge Using the Organizational Format

In one or more embodiments of the invention, users may access content using a non-CSI format. For example, as shown in FIG. 10, a user may click on or scroll down to a project management topic (e.g., “Preconstruction—Value Engineering”) in the left column (1001) of the home page. In one or more embodiments of the invention, as shown in FIG. 10, project management topics may be formatted as lessons learned or as best practice articles (1002), similar to the best practice articles in the CSI format. In one or more embodiments of the invention, forms and examples can be uploaded and linked (1103) to a topic or page. Similar to the Best Practice articles in CSI format, topic-specific questions (1105) may be used to elicit additional project data or modifications. Links (e.g., 1001) may be provided to for example, professional, project, or contact information associated with one or more authors. The bulk of the content in the Best Practices section may derive from lessons learned meetings with project teams and meeting minutes.

In one or more embodiments, users may customize “master checklists” related to various project elements. For example, while in one or more embodiments, master checklists may only be modified by an administrator, project teams may migrate a master checklist to an online project workspace where all team members can edit it and add new project-specific content. In essence, project teams may use “master checklists” as templates to create their own, customized checklists, etc. In one or more embodiments, these “modified” checklists and content may be shared with other users.

In one or more embodiments of the invention, links (not shown) may also be provided to allow users to look up information about current and past projects. Available information can include, for example:
a. Who were the members of the project team?
b. Who are the subcontractors and how did they perform?
c. What is the current status of the project? What are the milestones?

Such information can be derived from records kept by an administrator, describing project team members, project status, and schedule milestones. These records may provide basic information for this section, but information can also be updated or corrected by the employees.

In one or more embodiments of the invention, a user may look up expert information from a page where queries can be run for Subcontractor, CSI Section, Project Name, or Subcontractor Staff (foreman, Project Manager (PM), estimator, etc.).

In one or more embodiments of the invention, various reports can be run on subcontractors. For example, subcontractors can be queried by any or all of:
a. Subcontractor Name
b. Project
c. CSI Section
d. Staff Name

In one embodiment, pull-down menus are provided for each variable.

Results can be displayed in any desired format, including for example:
a. Subcontractor info (names, performance notes)
b. Project information (start, finish date, team member names)
c. Performance Notes with name of Project Team member

Notification Requests

Returning to FIG. 2, in Step 211, users may request notifications (e.g., e-mail, text messages, audio, etc.) that particular content has been modified. For example, users may request notification regarding the addition or modification of content relating to one or more project elements. Alternatively, the user can also request reminders about specific topics at specified points in time. This allows the user to set reminders at the start of a project indicating when he or she wishes to be reminded about available content.

For example, as shown in FIG. 3, a “Request Notifications” link (305) may be included at the home page. Via the link, users may enter information about what notification they would like and what communication method they prefer (e.g., electronic mail, SMS or MMS messaging, audio message, interactive voice recording (IVR), etc.)

In one or more embodiments, users may request notifications regarding project progress. For example, user can enter project milestone dates and the names (and/or contacting information) of team members. Based on those milestones, the platform will send out alerts (e.g., email, voicemail, text messages, etc.) to the appropriate team members, asking them to review the recently completed activity and update the platform with feedback, if necessary. In one or more embodiments, an administrator must accept such notification requests and any project data and/or modifications submitted in response.

Once it is deployed, the present invention is able to generate high quality lessons learned content for all aspects of a project. The topic-specific questions and collaborative interface of the present invention allow input to be provided anytime in a structured manner and with minimal reliance on an editor or administrator. The knowledge-sharing tools displayed to users are designed to correspond to established project phases (pre-construction, buy-out, construction, etc.) and project management activities. Users can add input to this platform whenever they want, for whatever topic, and the stored content is easily retrievable.

Computer System Functionality

Embodiments of the invention may be implemented on virtually any type of computer regardless of the platform being used. For example, as shown in FIG. 11, a computer system (1100) includes one or more processor(s) (1102), associated memory (1104) (e.g., random access memory (RAM), cache memory, flash memory, etc.), a storage device (1106) (e.g., a hard disk, an optical drive such as a compact disk drive or digital video disk (DVD) drive, a flash memory stick, etc.), and numerous other elements and functionalities typical of today's computers (not shown). The computer (1100) may also include input means, such as a keyboard (1108), a mouse (1110), or a microphone (not shown). Further, the computer (1100) may include output means, such as a monitor (1112) (e.g., a liquid crystal display (LCD), a plasma display, or cathode ray tube (CRT) monitor). The computer system (1100) may be connected to a network (1114) (e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms. Generally speaking, the computer system (1100) includes at least the minimal processing, input, and/or output means necessary to practice embodiments of the invention.

Further, those skilled in the art will appreciate that one or more elements of the aforementioned computer system (1100) may be located at a remote location and connected to the other elements over a network. Further, embodiments of the invention may be implemented on a distributed system having a plurality of nodes, where each portion of the invention (e.g., financial management application, user account, financial account, financial transaction, rules repository, import engine, digital files, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

The knowledge management platform is innovative on several levels. First, the invention is the first in the construction industry to apply a structured framework approach to the organization of lessons learned and best practices. In the past, lessons learned or best practices have been collected as stand-alone documents and disseminated through disparate channels (e.g., meeting minutes, meetings or employee training presentations). The knowledge management platform is unique in that it captures nearly all corporate knowledge and organizes that knowledge into knowledge management tools, such as checklists, and other content that correlate to the day-to-day activities of a project team.

Second, the knowledge management platform is unique in that it translates these best practices and lessons learned into questions that can be used in checklists. By converting this knowledge into questions it becomes more generally applicable and is less wedded to the context in which it was created.

This invention is the first in the construction industry to taken a holistic approach to the problem of knowledge sharing. It is a culmination of nine years of research with various construction project teams to design a useful knowledge management system. The invention transcends the limited practice of collecting construction knowledge on an individual or even departmental level. It is the first platform to convert industry lessons learned into questions that apply to different project phases. This novel approach allows makes knowledge much more useful to future project teams. In the past efforts have focused on knowledge capture (input), but they never adequately addressed the dissemination of knowledge (output), and they failed as a result.

By converting lessons learned into checklists that correlate to the day-to-day activities and responsibilities of a project team, the knowledge management platform greatly increases the re-usability of knowledge. It is a useful tool that is readily available when needed. Also, the immediacy of this system ensures that it will be continually updated with new insights, which is a functionality missing in existing database systems

The invention has successfully fulfilled a long-felt need in the construction industry for a knowledge platform that not only captures corporate knowledge, but effectively disseminates it. Clients are willing to license all components (software platform and content) of this system for several reasons, including that the platform has an intuitive organization of content, a user-friendly interface, useful content (including checklists), and may be updated with ease.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computer-based method for organizing a knowledge management platform to gather and share knowledge learned by a plurality of construction project teams, said method comprising:
authorizing access to the knowledge management platform, wherein the knowledge management platform comprises an integrated organizational scheme for organizing a construction project into one or more project elements;
facilitating input of project data into the knowledge management platform and storing project data based on the integrated organizational scheme, wherein project data comprises the knowledge learned by a plurality of construction project teams;
linking project data to one or more project elements in the integrated organizational scheme to obtain content; and
presenting the content to a plurality of user computers responsive to a request submitted to the knowledge management platform.

2. The method of claim 1, further comprising:
displaying the knowledge management platform in an interactive online environment using a web service.

3. The method of claim 1, further comprising:
modifying the content based on input from at least one of the plurality of user computers.

4. The method of claim 3, further comprising:
notifying at least one of the plurality of user computers that the content in a particular project element is modified.

5. The method of claim 1, wherein the one or more project elements comprise project management topics and technical content.

6. The method of claim 1, wherein the one or more project elements are input by at least one member of the plurality of construction project teams.

7. The method of claim 1, wherein the organizational scheme is based on a Construction Specifications Institute (CSI) format.

8. The method of claim 1, wherein content comprises a technical article and a knowledge-sharing tool.

9. The method of claim 1, wherein project data is obtained from at least one member of the plurality of construction project teams using topic-specific questions.

10. The method of claim 1, wherein project data is approved by an administrator prior to presenting the project data as content.

11. The method of claim 1, wherein the integrated organizational scheme comprises a top level and a secondary level, wherein the top level comprises a project management topic and a technical topic, and wherein the secondary level comprises a knowledge-sharing tool, content, and a topic-specific question.

12. The method of claim 1, wherein presenting the content comprises displaying the content on at least one of a plurality of user computing devices.

13. A system for organizing a knowledge management platform to gather and share knowledge learned by a plurality of construction project teams, said system comprising:
a server, communicatively connected to a plurality of user computers, configured to receive project data;
an authorization module, operatively connected to the server, comprising functionality to authorize access to the knowledge management platform, wherein the knowledge management platform comprises an integrated organizational scheme for organizing a construction project into one or more project elements;
a content management module, operatively connected to the server, configured to:
facilitate input of project data into the knowledge management platform, wherein project data comprises the knowledge learned by the plurality of construction project teams, and
link project data to one or more project elements in the integrated organizational scheme to obtain content;
a user interface, operatively connected to the plurality of user computers, configured to present the content to at least one of the plurality of user computers responsive to a request submitted to the knowledge management platform; and
a project data repository, operatively connected to the server, configured to store project data based on the integrated organizational scheme.

14. The system of claim 13, wherein the user interface is further configured to display the knowledge management platform in an interactive online environment using a web service.

15. The system of claim 13, wherein the content management module is further configured to facilitate modification of the content based on input from at least one of the plurality of user computers.

16. The system of claim 13, wherein the content editor module is further configured to notify at least one of the plurality of user computers that the content in a particular project element is modified.

17. The system of claim 13, wherein the knowledge management platform is configured to communicated with the user interface via an Extensible Markup Language (XML)-based protocol.

18. The system of 17, wherein the plurality of user computers are further configured to interact with at least one component of the knowledge management platform across a network via the user interface.

19. The system of claim 13, wherein one or more project elements comprise project management topics and technical content.

20. The system of claim 13, wherein project data is obtained from at least one member of the plurality of construction project teams.

21. The system of claim 13, wherein project data is approved by an administrator prior to presenting the project data as content.

22. The system of claim 13, wherein the content editor module is further configured to allow the plurality of user computers to export content using one or more file formats.

23. The system of claim 13, wherein the knowledge management platform comprises modular information architecture that may be implemented on a piecemeal basis.

24. The system of claim 13, wherein the integrated organizational scheme comprises a top level and a secondary level, wherein the top level comprises a project management topic and a technical topic, and wherein the secondary level comprises a knowledge-sharing tool, content, and a topic-specific question.

25. The system of claim 13, wherein the organizational scheme is based on a Construction Specifications Institute (CSI) format.

26. A computer readable medium storing instructions for organizing a knowledge management platform to gather and share knowledge learned by construction project teams, the instructions comprising functionality for:
authorizing access to the knowledge management platform, wherein the knowledge management platform comprises an integrated organizational scheme for organizing a construction project into one or more project elements;
facilitating input of project data into the knowledge management platform and storing project data based on the integrated organizational scheme, wherein project data comprises the knowledge learned by a plurality of construction project teams;
linking project data to one or more project elements in the integrated organizational scheme to obtain content; and
presenting the content to a plurality of user computers responsive to a request submitted to the knowledge management platform.

27. The computer readable medium of claim 26, the instructions comprising further functionality to display the knowledge management platform in an interactive online environment using a web service.

28. The computer readable medium of claim 26, the instructions comprising further functionality to modify the content based on input from at least one of the plurality of user computers.

29. The computer readable medium of claim 26, the instructions comprising further functionality to notify at least one of the plurality of user computers that the content in a particular project element is modified.
